(19) United States
(12) Patent Application Publication
(10) Pub. No.: US 2010/0211308 A1
(43) Pub. Date: Aug. 19, 2010

(54) IDENTIFYING INTERESTING LOCATIONS

(75) Inventors: Yu Zheng, Beijing (CN); Lizhu Zhang, Beijing (CN); Xing Xie, Beijing (CN); Wei-Ying Ma, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/388,901

(22) Filed: Feb. 19, 2009

(51) Int. Cl. G01C 21/02; G01C 21/00; G06F 17/18; G06F 17/30; G06N 5/02; G06N 5/04; G06F 7/06

(52) U.S. Cl. 701/201; 702/180; 701/213; 706/46; 706/52; 707/E17.018; 707/E17.05; 707/E17.046

(57) ABSTRACT

Interesting location identification embodiments are presented that generally involve identifying and providing the interesting locations found in a given geospatial region. This is accomplished by modeling the location histories of multiple individuals who traveled through the region of interest, and identifying interesting locations in the region based on the number of individuals visiting a location weighted in terms of the travel experience of those individuals. A prescribed number of the top most interesting locations in a specified region can be provided upon request. In addition, prescribed numbers of the top most popular travel sequences through the interesting locations and the top most experienced travelers in the specified region can be provided as well.

### BACKGROUND

The increasing availability of devices enabled with a global positioning system (GPS), like GPS-phones, is changing the way people interact with the Word Wide Web. For example, a user is able to acquire his or her present location, search the information based on this location and design driving routes to a destination. In recent years, many users have started recording their movements with GPS trajectories. This is done for a variety of reasons, such as travel experience sharing, life logging, sports activity analysis and multimedia content management, among others.

Additionally, websites and forums have appeared recently on the Internet, which allow people to establish geo-related web communities. By uploading GPS logs to these communities, individuals are able to visualize and manage their GPS trajectories on a Web map. Further, they can obtain reference knowledge from others' life experiences by sharing these GPS logs among each other. For instance, a person is able to find some places that attract them from other people' travel routes, and hence, plan an interesting and efficient journey based on multiple users' experiences.

Given the pervasiveness of the GPS-enabled devices, and peoples' logging and sharing of their movements, a large amount of GPS trajectory data representing people's location histories is available on the Web.

### SUMMARY

This Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter.

Interesting location identification embodiments described herein involve identifying and providing the interesting locations found in a given geospatial region. Generally, this is accomplished by modeling the location histories of multiple individuals who traveled through the region of interest, and identifying interesting locations in the region based on the number of individuals visiting a location weighted in terms of the travel experience of those individuals.

In one implementation, the modeling and interesting location identification involves first inputting the location histories of multiple individuals. These location histories generally include a log of periodically captured geospatial locations which were visited by one or more of the individuals in the aforementioned region over a period of time. So-called stay points are extracted from the location histories. A stay point is a geospatial position in the region which is within a prescribed maximum distance of locations where an individual spent a period of time exceeding a prescribed minimum period. A tree-based hierarchical graph (TBHG) is generated from the extracted stay points. This TBHG models the multiple individuals' stay points as locations on each of a plurality of scaled geospatial levels. A hypertext induced topic search (HITS)-based inference model is then employed to establish a measure of the relative interest of the locations in the geospatial region at each of the plurality of geospatial levels of the TBHG. A listing of the interesting locations in the geospatial region at each of the plurality of geospatial levels of the TBHG is stored along with the measure of the relative interest established for the interesting locations. Upon request, a prescribed number of the top interesting locations associated with a specified region are provided. In addition, prescribed numbers of the top most popular travel sequences through the interesting locations and the top most experienced travelers among the aforementioned multiple individuals can be provided as well.

### DESCRIPTION OF THE DRAWINGS

The specific features, aspects, and advantages of the disclosure will become better understood with regard to the following description, appended claims, and accompanying drawings where:

FIG. 1 is a flow diagram generally outlining one embodiment of a process for identifying interesting locations in a geospatial region.

FIG. 2 is a simplified diagram of a suitable architecture for implementing the program modules of the interesting location identification embodiments.

FIG. 3 is a flow diagram generally outlining one embodiment of a process for implementing an aspect of interesting location identification involving GPS data modeling.

FIG. 4 is a simplified diagram depicting a GPS trajectory and stay point associated therewith.

FIGS. 5A-B are a continuing flow diagram generally outlining one embodiment of a process for implementing an aspect of interesting location identification involving building a tree-based hierarchical graph (TBHG).

FIG. 6 is a simplified diagram depicting a exemplary three-level TBHG on the left hand side, and a corresponding tree-based hierarchy on the right hand side.

FIG. 7 is a simplified diagram depicting the mutual reinforcement relationship between authorities and hubs in a hypertext induced topic search scheme.

FIG. 8 is a simplified diagram depicting a HITS-based inference model.

FIG. 9 is a simplified diagram depicting a tree-based hierarchy used to illustrate the choice of a region including two locations descendant from the same parent cluster.

FIG. 10 is a simplified diagram depicting a tree-based hierarchy used to illustrate the choice of a region including three locations descendant from more than one parent cluster.

FIG. 11 is a flow diagram generally outlining one embodiment of a process for implementing an aspect of interesting location identification involving computing authority and hub scores using Hypertext Induced Topic Search (HITS)-based inference modeling.

FIG. 12 is a flow diagram outlining one embodiment of a process for identifying interesting locations in a geospatial region and providing them to a remote computing device.

FIG. 13 is a simplified diagram depicting an exemplary graph from a level of a TBHG.

FIG. 14 is a flow diagram generally outlining one embodiment of a process for computing a commonality score for a two location-length travel sequence.

FIG. 15 is a diagram depicting a general purpose computing device constituting an exemplary system for implementing the interesting location identification embodiments described herein.

### DETAILED DESCRIPTION

In the following description of interesting location identification embodiments reference is made to the accompanying drawings which form a part hereof, and in which are shown, by way of illustration, specific embodiments in which the technique may be practiced. It is understood that other embodiments may be utilized and structural changes may be made without departing from the scope of the technique.

### 1.0 INTERESTING LOCATION AND TRAVEL SEQUENCE IDENTIFICATION

The interesting location identification embodiments described herein generally employ the previously-described GPS trajectory data to identify interesting locations and travel sequences within given geospatial regions. Typically, people would desire to know which locations are the most interesting places in a geospatial region. These interesting locations include culturally important places and popular tourist destinations (e.g., Tiananmen Square in Beijing, the Statue of Liberty in New York, and so on) and other frequented public areas (e.g., shopping malls, restaurants, cinemas, and so on). Further, given interesting locations in a geospatial region like a city, users might also wonder what the most common travel sequences are among them. For example, an individual would be more likely to go to a bar after visiting a cultural landmark than they would before—thus making the landmark-to-bar a more common travel sequence than the reverse.

With information on interesting locations and common travel sequences, users can quickly familiarize themselves with a city and plan their journeys with minimal efforts. This is particularly useful for a “mobile” user who is accessing the information using a mobile communication device. Such information can also be employed to generate travel recommendations and create a tourist guide. In general, given the recommendation of the interesting places and travel sequences around them, mobile users are more likely to enjoy a high quality travel experience while saving time in finding interesting locations and planning a trip.

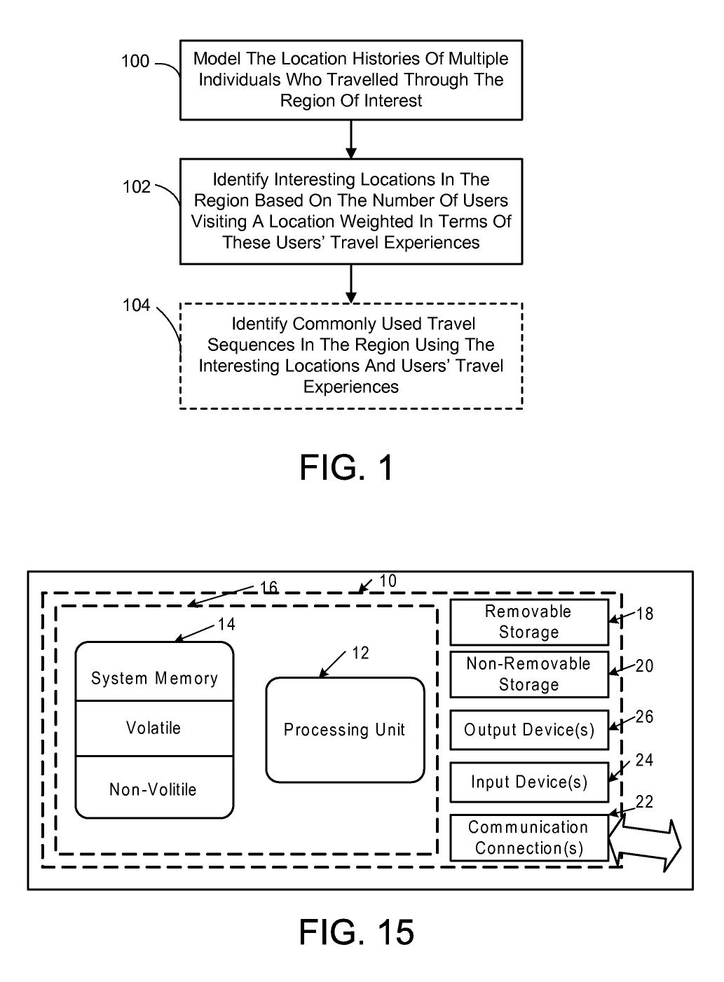

Referring to FIG. 1, in one embodiment, identifying interesting locations in a geospatial region involves first modeling the location histories of multiple individuals who traveled through the region (action 100). In an implementation of this action, a tree-based hierarchical graph (TBHG) was employed to perform the modeling. The TBHG can model multiple users' travel sequences on a variety of geospatial scales based on their GPS trajectories. This TBHG implementation will be described in more detail in a section to follow.

The location history model is then used to identify interesting locations. It is noted, however, that in inferring the interest of a location from modeled location history data, the following considerations play a factor. First, the interest of a location does not only depend on the number of users visiting it, but also in the travel experiences of the users. In fact, there is a mutual reinforcement relationship between location interest and user travel experience. In addition, user travel experience and location interest are region-related. Thus, users with more travel experiences in a region would be more likely to visit some interesting locations in that region. For instance, the local people of Beijing are more likely than tourists to visit high quality restaurants and famous shopping malls in Beijing. This concept scales up and down as well. For instance, the most interesting restaurant in a district of a city might not be the most interesting one of the whole city.

In general, the foregoing considerations are addressed by identifying interesting locations in a region based on the number of users visiting a location weighted in terms of these users' travel experiences in the region (action 102). In an implementation of this action, a Hypertext Induced Topic Search (HITS)-based inference model is employed to infer a user's travel experience in a region and the relative interest of a visited location in that region. More particularly, this HITS model regards an individual's visit to a location as a directed link from the user to that location, which is then weighted by the user's travel experience in the region. Intuitively, a user with rich travel experiences in a region will visit many interesting places in that region, and a very interesting place in that region will be accessed by many users with rich travel experiences. In the context of the HITS model this means each user would have experience-weighted links to many locations and each location would be linked in experience-weighted amounts to many users.

Referring again to FIG. 1, in an optional action, commonly used travel sequences can be identified in a specified region using the previously-determined interesting locations and users' travel experiences for that region (action 104). The optional nature of this last action is indicated in FIG. 1 by the use of a broken line box. In one implementation, this is accomplished by computing peoples transition probability between locations.

### 1.1 Architecture

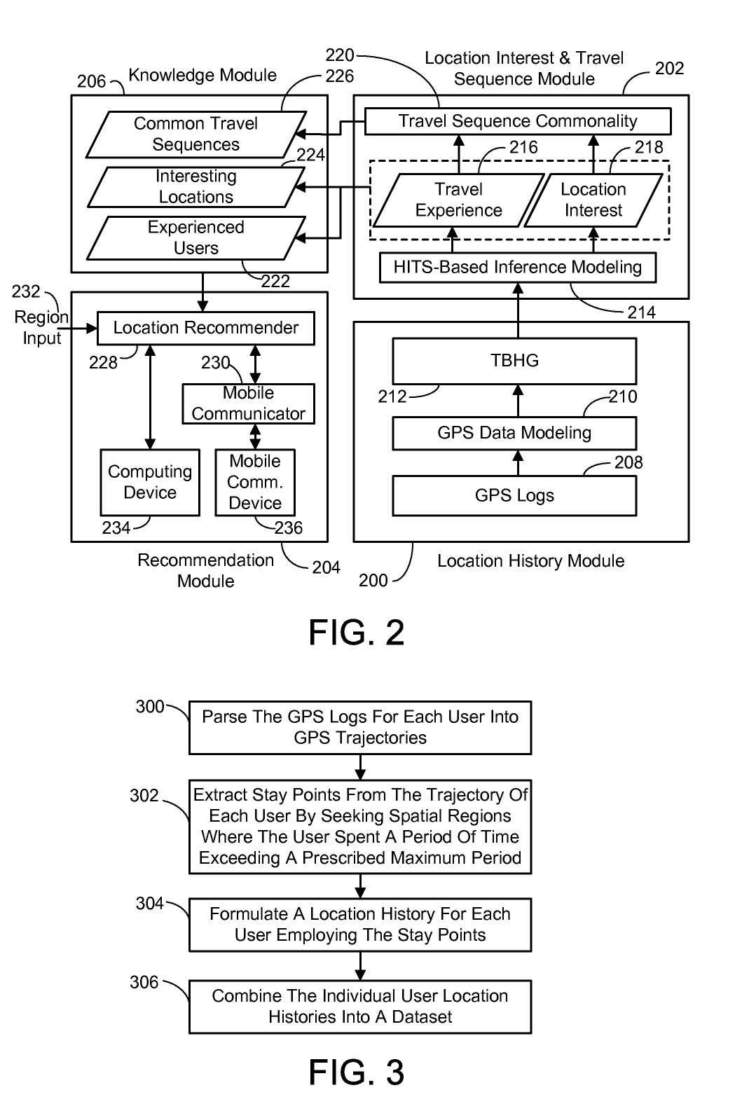

FIG. 2 illustrates one version of a suitable architecture for the program modules making up the interesting location identification embodiments described herein. There are three main operational modules—namely a location history modeling module 200, a location interest and travel sequence module 202, and a recommendation module 204. The operations associated with the first two modules can be performed off-line to save time when making recommendations, while the operations associated with the recommendation module are conducted on-line based on a region specified by a user. The architecture can also include a knowledge module 206 for storing the output of the location interest and travel sequence module 202. This is particularly useful in embodiments where the location interest and travel sequence module is performed off-line.

### 1.1.1 Location History Modeling Module

The location history modeling module 200 includes an input sub-module and two operational sub-modules. The input sub-module is the GPS logs sub-module 208, and it is responsible for obtaining the GPS logs of multiple users' for the geospatial region of interest. These logs can be obtained from, for example, the previously-described websites and forums that share users' GPS logs. A GPS log is generally a collection of GPS points P={p₁, p₂, . . . , pₙ}. Each GPS point pᵢεP contains latitude (pᵢ.Lat), longitude (pᵢ.Lngt) and timestamp (pᵢ.T) values.

The first operational sub-module is the GPS data modeling sub-module 210, which is responsible for transforming the raw GPS data into a form that can be readily used to create a TBHG. The second operational sub-module is a TBHG sub-module 212, which is responsible for constructing a TBHG from the modeled location history data. The operations of these two sub-modules will be described in more detail in sections to follow.

### 1.1.2 Location Interest and Travel Sequence Module

The location interest and travel sequence module 202 can include two operational sub-modules (one of which is optional). The non-optional sub-module is the HIST-based inference model sub-module 214, which is responsible for estimating users' travel experiences 216 and location interests 218 in a given region. The optional sub-module is a travel sequence commonality sub-module 220, which uses the users' travel experiences 216 and location interests 218 estimates to identify common travel sequences between the interesting locations. The operations of these two sub-modules will be described in more detail in sections to follow.

### 1.1.3 Knowledge Module

As stated previously, the purpose of the knowledge module 206 is to store the output of the location interest and travel sequence module 202. More particularly, the knowledge module stores lists of experienced users 222 and interesting locations 224. Further, if the optional common travel sequence sub-module 220 is employed, the knowledge module 206 also stores a list of common travel sequences 226 between the interesting locations in the applicable region.

### 1.1.4 Recommendation Module

The recommendation module 204 includes a location recommender sub-module 228 and optionally a conventional mobile communicator sub-module 230. The location recommender sub-module 228 takes an input 232 that specifies the particular geospatial region for which it is desired to obtain interesting locations. This input 232 can be accomplished in a variety of ways. For example, the person providing the input could be viewing a map of the region of interest on a display of a computing device 234 (e.g., a laptop or personal computer), of on the display of a mobile communication device 236 (e.g., a mobile telephone). By changing the zoom level of a displayed map and/or moving the map, an individual can select any geospatial region for which data is stored in the knowledge module. This selected region is then input into the location recommender sub-module, which may be through the aforementioned optional mobile communicator sub-module 230 if the person is using a mobile communication device 236 (as shown in FIG. 2). The selected region can cover for example a whole country or a part of a city. With the received region selection, the recommender sub-module 228 determines the corresponding level of hierarchy in TBHG, and then identifies the locations (clusters) that fall in the given region on this level. The recommender sub-module 228 can also identify experienced users associated with the selected region, and (when implemented) common travel sequences associated with the identified interesting locations. As will be described in subsequent sections, part of the HIST-based inference modeling procedure is to generate hub and authority scores. This information is used by the recommender sub-module 228 to rank the identified interesting locations and experience users. Then, a prescribed number k of the highest ranked experienced users, a prescribed number n of the highest ranking interesting locations, and (if applicable) a prescribed number m of the highest ranking common travel sequences within the specified region can be returned to the requester who selected the region. This returned information can go back via the same communication channel that was used to provide the region selection and can be routed through the mobile communicator sub-module 230 if appropriate.

### 1.2 Operations

The operations of the foregoing GPS data modeling, TBHG, HIST-based inference model, and common travel sequence sub-modules will now be described in more detail.

It is noted that in the description to follow certain notations will be used for the sake of simplicity. More particularly, U={u₁, u₂, . . . , uₙ} represents the collection of users in a community, uₖεU, 1≦k≦|U| denotes the kth user. p^{k}, Traj^{k}, S^{k} and LocH^{k} respectively stand for the uₖ's GPS logs, GPS trajectories, stay points and location history.

### 1.2.1 GPS Data Modeling

Referring to the process flow diagram of FIG. 3, GPS data modeling generally entails first parsing the GPS logs p^{k} for each user uₖεU into GPS trajectories Traj^{k} (action 300). Next, stay points s^{k} are extracted from the trajectory of each user by seeking the spatial regions where uₖ spent a period of time exceeding a prescribed maximum period (action 302). Then, a location history LocH^{k} is formulated for each user employing the extracted set of stay points S^{k} (action 304). The individual user location histories are then combined into a dataset (action 306) SP={S^{k}, 1≦k≦|U|}, and the modeling ends.

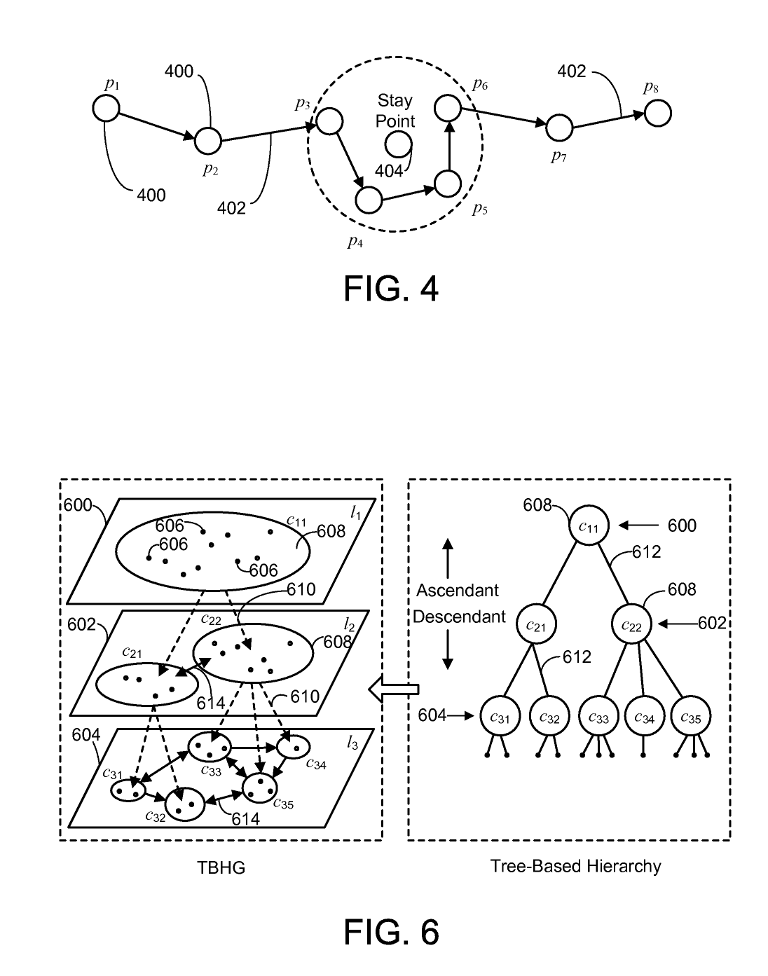

In regard to the aforementioned action of parsing the GPS logs for each user into a GPS trajectory, in one embodiment this is accomplished as follows. As shown in FIG. 4, on a two dimensional plane, GPS points can be sequentially connected into a curve based on their timestamps. This curve is then split into the GPS trajectory segments 402, where each segment corresponds to a part of the curve having a time interval between beginning and ending GPS points that exceeds a prescribed threshold ΔT. Thus, Traj=p₁→p₂→ . . . →pₙ, where pᵢεP, pᵢ₊₁.T>pᵢ.T and pᵢ₊₁.T−pᵢ.T>ΔT (1≦i<n). Note that each trajectory segment has a beginning and ending GPS point (which will be referred to as trajectory points 400) and can have intermediate GPS points as well.

In regard to the aforementioned action of extracting stay points, a stay point s generally refers to a geographic region where a user stayed over a certain time interval. Typically, these stay points occur in the following two situations. One is when an individual remains stationary for period of time exceeding a time threshold. In many cases, this occurs when people enter a building and lose the GPS satellite signal over a time interval until coming back outdoors. The other situation is when a user wanders around within a certain geospatial range for a period of time. In most cases, this occurs when people travel outdoors and are attracted by something in the surrounding environment. As compared to a raw GPS point, each stay point carries a particular semantic meaning, such as the shopping malls a user accessed or the restaurants a user visited, and so on.

The extraction of a stay point depends on two prescribed scale parameters, a time threshold (Tₜₕᵣₑₕ) and a distance threshold (Dₜₕᵣₑₕ). For example, considering the trajectory points {p₃, p₄, p₅, p₆} shown in FIG. 4. A stay point s 404 is a virtual location characterized by a group of consecutive qualifying trajectory points 400, where the points qualify if the distance between the points is less than or equal to a prescribed distance threshold (i.e., Dₜₕᵣₑₕ) and the time interval between the points equals or exceeds a prescribed time period (i.e., Tₜₕᵣₑₕ). For a group of consecutive qualifying trajectory points, their average latitude and longitude is computed, as well as an arrival time (which corresponds to the timestamp of the earliest point in the group) and a leaving time (which corresponds to the timestamp of the latest point in the group). These parameters are used to define the stay point (i.e., s=(Lat, Lngt, arvT, levT)). More particularly, for a group of trajectory points P={pₘ, pₘ₊₁, . . . , pₙ}, where ∀m<i≦n, Distance (pₘ, pᵢ)≦Dₜₕᵣₑₕ and |pₙ.T−pₘ.T≧Tₜₕᵣₑₕ a stay point s=(Lat, Lngt, arvT, levT) is computed as follows:

$$\begin{matrix}s . Lat = {\sum }_{i = m}^{n} {p}_{i} . Lat / \vert P \vert ; & ( 1 ) \\ s . Lngt = {\sum }_{i = m}^{n} {p}_{i} . Lngt / \vert P \vert ; & ( 2 )\end{matrix}$$

respectively, refer to the average latitude and longitude of the collection P, and s.arvT=pₘ.T and s.levT=pₙ.T represent a user's arrival and leaving times on s. In tested embodiments, Dₜₕᵣₑₕ was set to 200 meters and Tₜₕᵣₑₕ was set to 20 minutes with success. However, it is noted that Dₜₕᵣₑₕ and Tₜₕᵣₑₕ can vary depending on the application and scale of the region.

In regard to the aforementioned location history formulation action, generally, a location history is a record of locations that an entity visited in geographical spaces over a period of time. In the present context, an individual's location history (LocH^{k}) is represented as a sequence of stay points (s) he or she visited with corresponding arrival (arvT) and leaving (levT) times. Thus,

$$LocH = ( {s}_{i} {}^{Δ {t}_{1}} {s}_{2} {}^{Δ {t}_{2}} , … , {}^{Δ {t}_{n - 1}} {s}_{n} ) ;$$

$$Δ {t}_{i} = {s}_{i + 1} . arvT - {s}_{i} . levT .$$

### 1.2.2 Tree-Based Hierarchical Graph (TBHG)

It is noted that the location histories of various people tend to be inconsistent and incomparable as the stay points pertaining to different individuals are typically not identical. To address this issue, the aforementioned TBHG structure is used to model multiple users' location histories. In this structure, a graph node stands for a cluster of stay points, and a graph edge represents a directed transition between two clusters. In contrast to raw GPS points, these clusters denote the locations visited by multiple users, hence would carry more semantic meaning, such as culturally important places and commonly frequented public areas. In addition, the hierarchy of TBHG denotes different geospatial scales like a city, a district and a community. In short, the tree-based hierarchical graph can effectively model multiple users' travel sequences on a variety of geospatial scales.

Generally speaking, a TBHG is the integration of two structures, a tree-based hierarchy H and a graph G on each level of this tree (i.e., TBHG=(H, G)). The tree expresses the parent-children (or ascendant-descendant) relationship of the nodes pertaining to different levels, and the graphs specify the peer relationships among the nodes on the same level.

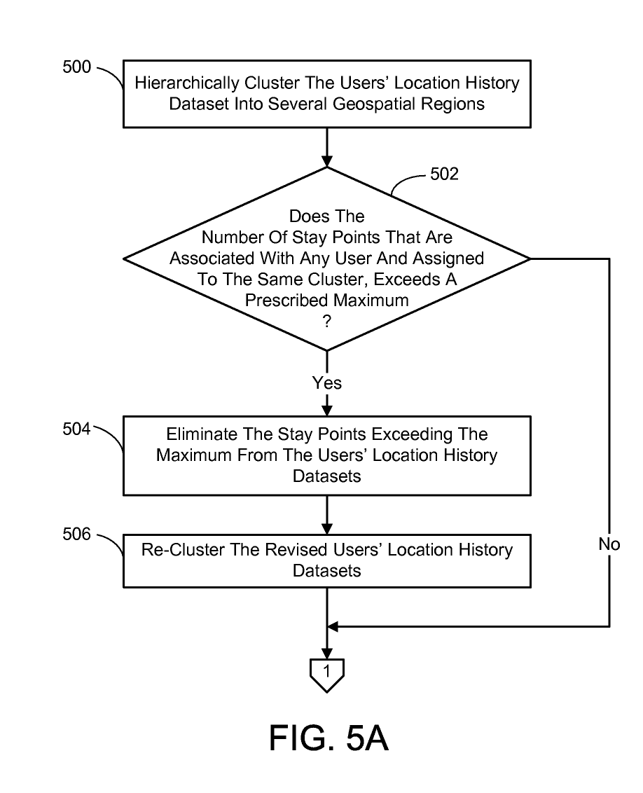

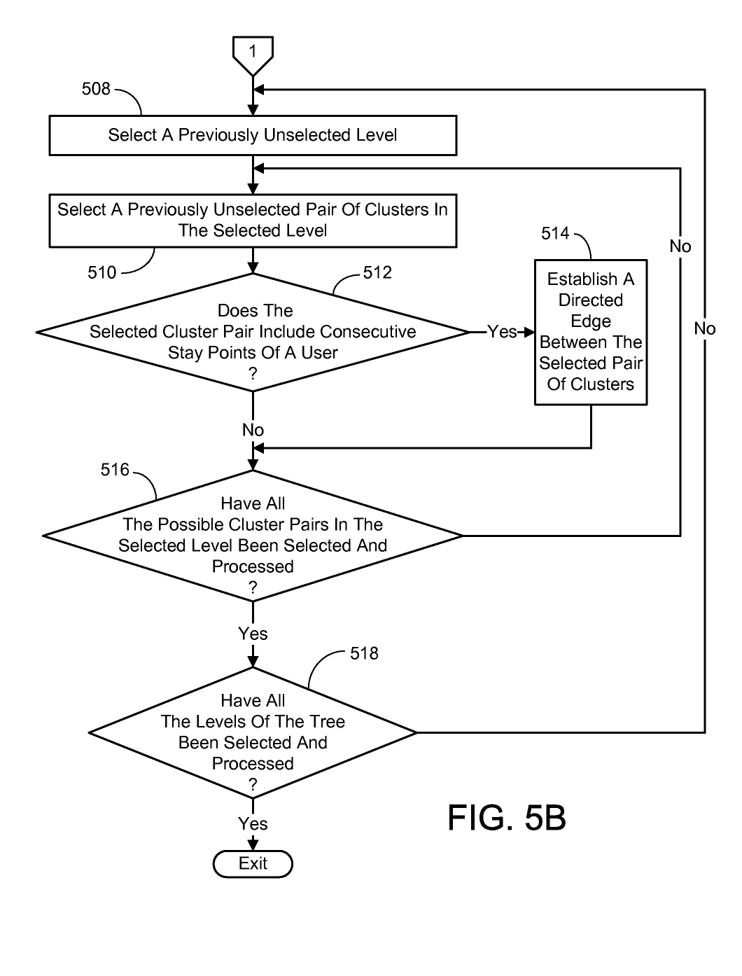

In one implementation two steps are used to build a TBHG. First, a tree-based Hierarchy H is formulated. Referring to FIGS. 5A-B, this entails using a density-based clustering technique (e.g., the ordering points to identify the clustering (OPTIC) technique) to hierarchically cluster the aforementioned users' location history datasets into several geospatial regions (clusters c) in a divisive manner (action 500). The clusters are then filtered to eliminate stay points from consideration that likely correspond to a user's home or workplace. For example, as exemplified in FIG. 5A, it is determined if the number of stay points that are associated with an individual user and assigned to the same cluster, exceeds a prescribed maximum number (action 502). If so, it is assumed the stay points are associated with that individual's home or work place and they are eliminated from the users' location history dataset (action 504). The now revised users' location history dataset is then re-clustered in the same manner as before (action 506). If however, it is determined in action 502 that the number of stay points associated with each of the individual users does not exceed the prescribed maximum in any of the clusters, then actions 504 and 506 are skipped, as shown in FIG. 5A.

The result of the foregoing clustering is that similar stay points from various users are assigned to the same clusters on different levels. More particularly, H is a collection of stay point-based clusters c with a hierarchy structure L. H=(C,L), L={l₁, l₂, . . . , lₙ} denotes the collection of levels of the hierarchy and C={cᵢⱼ|1≦i≦|L|, 1≦j≦|Cᵢ|} refers the collection of clusters on different levels. Here, cᵢⱼ represents the jth cluster on level lᵢεL, and Cᵢ is the collection of clusters on level lᵢ.

Graphs are built next on each level of the tree by using the tree-based hierarchy H and the users' location histories to connect clusters of the same level with directed edges. To this end, referring to FIG. 5B, a previously unselected level is selected (action 508), and a previously unselected pair of clusters in the selected level is selected as well (action 510). It is then determined if the selected cluster pair includes consecutive stay points pertaining to a user's location history based on the timestamp of the two stay points (action 512). If so, a directed edge is established between the selected pair of clusters (action 514). More particularly, G={gᵢ=(Cᵢ,Eᵢ), 1<i≦|L|}, and on each layer lᵢεL, gᵢεG includes a set of vertexes Cᵢ and the edges Eᵢ connecting cᵢⱼεCᵢ. Once the directed edge is established, or if it was determined the selected cluster pair did not included consecutive stay points, then it is determined if all the possible cluster pairs in the selected level have been selected and processed (action 516). If unselected pairs exist, actions 510 through 516 are repeated. Otherwise, it is determined if all the levels of the tree have been selected and processed (action 518). If not, then actions 508 through 518 are repeated. Once all the levels have been considered, the procedure ends.

A simplified exemplary result of the foregoing TBHG technique is shown in FIG. 6. This example has three levels—namely l₁ (600), l₂ (602) and l₃ (604). In the left hand side of FIG. 6 (which represents the TBHG), the levels 600, 602, 604 are shown as planes, and in the right hand side (which represents a tree-based hierarchy), they are shown as the three cluster rows. On each level, the individual stay points are clustered. The solid dots 606 (in the left hand side of the figure) each represent a stay point and the circles 608 (in both sides of the figure) each represent a cluster of stay points. The clusters are identified by their level and their index number on each level as described previously. Thus, for example, the two clusters on the second level l₂ are identified as clusters c₂₁ and c₂₂. The dashed line arrows 610 between levels on the left hand side, and the solid arrows 612 between levels on the right hand side of FIG. 6, represent associations between clusters on adjacent levels. For example, note that cluster c₂₁ on the second level l₂ is associated with (i.e., is the parent node of) the clusters c₃₁ and c₃₂ on the third level l₃. The solid arrows 614 between the clusters in the same level on the left hand side of FIG. 6 represent the aforementioned directed edges. For example, in the third level l₃, there is a link between cluster c₃₁ and both clusters c₃₂ and c₃₃.

### 1.2.3 HIST-Based Inference Model

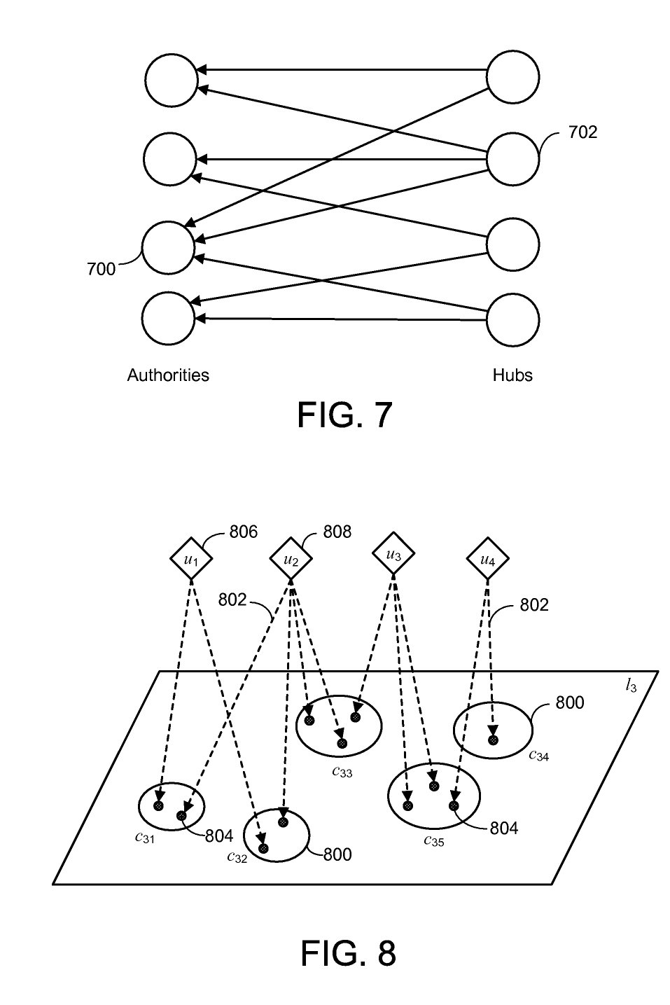

A hypertext induced topic search (HITS) is a search-query-dependent ranking technique for Web information retrieval. When the user issues a search query, HITS first expands the list of relevant pages returned by a search engine and then produces two rankings for the expanded set of pages, authority ranking and hub ranking. For every page in the expanded set, HITS assigns them an authority score and a hub score. As shown in FIG. 7, an authority 700 is a Web page with many in-links, and a hub 702 is a page with many out-links. The key idea of HITS is that a good hub points to many good authorities, and a good authority is pointed to by many good hubs. Thus, authorities and hubs have a mutual reinforcement relationship. More specifically, a page's authority score is the sum of the hub scores of the pages it points to, and its hub score is the integration of authority scores of the pages pointed to by it. Using a power iteration method, the authority and hub scores of each page can be calculated. The main strength of HITS is ranking pages according to the query topic, which may provide more relevant authority and hub pages.

In the interesting location identification embodiments described herein, the HITS technique is adapted for use as an inference model to identify experienced users and interesting locations. In general, an experienced user in a region is one with rich travel experiences in that region. As will be described below, such a user will have a relatively high hub score. Further, an interesting location is one that attracts people's profound interests. As will be described below, an interesting location is one that has a relatively high authority score.

In the HITS-based inference model, an individual's visit to a location (cluster) is regarded as a directed link from the individual to that location. Thus, a user is a hub if they have visited many locations in a region of interest, and a location is an authority if it has been accessed by many users. Further, a user's travel experience (hub score) and the interest of a location (authority score) have a mutual reinforcement relationship. Using a power iteration method, it is possible to generate the final scores for each user and location, and rank the top n interesting locations and the top k experience users in a given region.

As a user's travel experience is region-related, a geospatial region is specified as the context for the inference model. As stated previously, interesting locations and experienced users are identified off-line for a variety of geospatial regions. This is where the hierarchical nature of the TBHG can be exploited to advantage. Each cluster of the TBHG specifies an implied region for its descendant clusters (locations). Therefore, each individual's travel experience and interests of locations can be mined from the TBHG conditioned by the regions of clusters on different levels. After the HITS-based inference modeling is complete, each user will have multiple hub scores based on different regions, and a location will have multiple authority scores specified by their ascendant clusters on different levels. This strategy takes the advantage of HITS model in ranking locations and users based on a region context (query topic), while making the calculations of authority and hub scores off-line.

In the sections to follow the HITS-based inference modeling will be described in more detail.

### 1.2.3.1 Model Description

Using the third level l₃ of the simplified TBHG shown in FIG. 6 as an example, FIG. 8 illustrates the HITS-based inference model. Here, a location is a cluster of stay points 800, like c₃₁ and c₃₂. An individual's visit to a location is regarded as an implicitly directed link 802 from the individual to that location. For instance, cluster c₃₁ contains two stay points 804 respectively detected from u₁ 806 and u₂'s 808 GPS trajectory, i.e., both u₁ and u₂ have visited this location. Thus, two directed links 802 are generated respectively to point to c₃₁ from u₁ 806 and u₂ 808. Analog to HITS, in this model, a hub is a user who has accessed many places, and an authority is a location which has been visited by many users. Therefore, users' travel experiences (hub scores) and the interests of locations (authority scores) have a mutual reinforcement relationship.

### 1.2.3.2 Strategy for Data Selection

Intrinsically, a user's travel experience is region-related, i.e., a user who has extensive travel knowledge of a city might have no idea about another city. Also, an individual, who has visited many places in a part of a city, might know little about another part of the city (if the city is very large, like New York). This feature is aligned with the query-dependent property of HITS. Thus, before conducting the HITS-based inference, a geospatial region (a topic query) is specified for the inference model and a dataset that contain the locations falling in this region is generated.

To avoid the need for a large amount of time consuming processing to respond to a person's input to identify the interesting locations in a specified region, the TBHG is used to pre-define hierarchical regions and the HITS-based inference model is used to calculate in advance the interesting locations and experience users associated with each of these regions. More particularly, on a level of the TBHG, the shape of a graph node (cluster of stay points) provides an implicit region for its descendent nodes. These regions covered by clusters on different levels of the hierarchy represent various semantic meanings, such as a city, a district and a community. Therefore, the interest of every location is pre-calculated using the regions specified by their ascendant clusters. In other words, a location might have multiple authority scores based on the different region scales it falls in. Also, a user might have multiple hub scores conditioned by the regions of different clusters. When a person requests interesting locations be identified in a specified region, pre-calculated interesting locations associated with the closest region corresponding to the specified region are provided.

### 1.2.3.3 Location Interest and User Travel Experience Representations

The interest of a location (cᵢⱼ) is represented by a collection of authority scores aᵢⱼ={aᵢⱼ¹, aᵢⱼ², . . . , aᵢⱼ¹}. Here, aᵢⱼ¹ denotes the authority score of cluster cᵢⱼ based on the region specified by its ascendant nodes on level l, where 1≦l≦i−1.

A user's (e.g., uₖ) travel experience is represented by a set of hub scores h^{k}={hᵢⱼ^{k}|1≦i<|L|, 1≦j<|Cᵢ|}, where hᵢⱼ^{k} denotes u^{k}'s hub score conditioned by the region of cᵢⱼ.

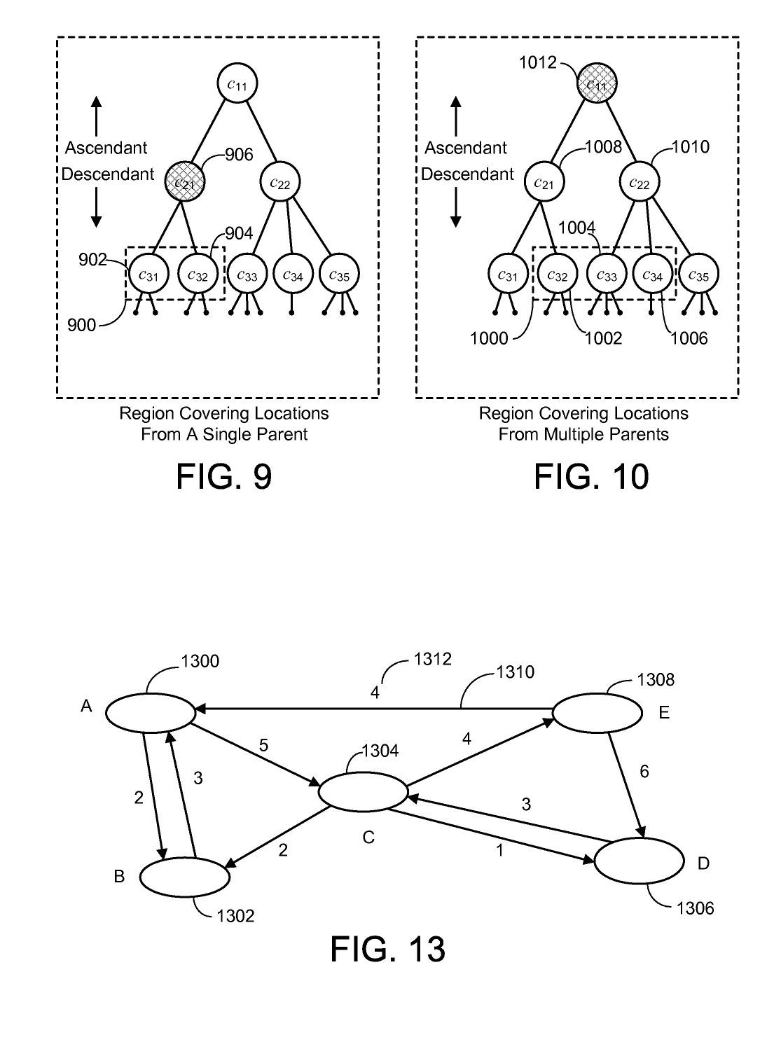

FIGS. 6 and 8 illustrate the foregoing representations. In the region specified by cluster c₁₁, an authority score (a₂₁¹ and a₂₂¹) can be respectively calculated for clusters c₂₁ and c₂₂. Meanwhile, within this region, it is possible to infer authority scores (a₃₁¹, a₃₂¹, a₃₃¹a₃₄¹ and a₃₅¹) for clusters c₃₁, c₃₂, c₃₃, c₃₄ and c₃₅. Further, using the region specified by cluster c₂₁, it is also possible to calculate another set of authority scores (a₃₁², and a₃₂²) for c₃₁ and c₃₂. Likewise, the authority scores (a₃₃², a₃₄² and a₃₅²) of c₃₃, c₃₄ and c₃₅ can be re-inferred with the region of c₂₂. Therefore, each cluster on the third level has two authority scores, which are used in various occasions based on the geospatial region input. For instance, as depicted in the FIG. 9, when a person selects a region 900 only covering locations c₃₁ 902 and c₃₂ 904, the authority scores a₃₁² and a₃₂² associated with c₂₁ 906 can be used to rank these two locations. However, as illustrated in FIG. 10, when the selected region 1000 covers the locations 1002, 1004, 1006 from two different parent clusters (c₂₁ 1008 and c₂₂ 1010), the authority values a₃₂¹, a₃₃¹ and a₃₄¹ associated with c₁₁ 1012 are used to rank these locations.

As stated previously, the foregoing strategy that sets multiple hub scores for a user and multiple authority scores for a location, has the following two advantages. First, it is possible to leverage the main strength of HITS to rank locations and users with the contexts of geospatial region (query topic). Second, these hub and authority scores can be calculated off-line.

### 1.2.3.4 Inference

Given a dataset of locations, it is possible to build an adjacent matrix M between users and locations based on the users' accesses on these locations. In this matrix, an item vᵢⱼ^{k} stands for the times that uₖ (a user) has visited cluster cᵢⱼ (a location), where cᵢⱼ is the jth cluster on the ith level of the TBHG. If uₖ has not visited cᵢⱼ, vᵢⱼ^{k} would be set to 0. For example, the matrix M for the case shown in FIG. 9 can be represented as follows.

$$M = \begin{matrix}{u}_{1} \\ {u}_{2} \\ {u}_{3} \\ {u}_{4}\end{matrix} {[ \begin{matrix}1 & 1 & 0 & 0 & 0 \\ 1 & 1 & 2 & 0 & 0 \\ 0 & 0 & 1 & 2 & 0 \\ 0 & 0 & 0 & 1 & 1\end{matrix} ]}^{\begin{matrix}{c}_{31} & {c}_{32} & {c}_{33} & {c}_{34} & {c}_{35}\end{matrix}} \qquad ( 3 )$$

Then, the mutual reinforcement relationship of the user travel experience hᵢⱼ^{k} and location interest aᵢⱼ^{l} is represented as follows:

$$\begin{matrix}{a}_{ij}^{l} = {\sum }_{{u}_{k} ∈ U}^{ } {v}_{ji}^{k} \times {h}_{lq}^{k} ; & ( 4 ) \\ {h}_{lq}^{k} = {\sum }_{{c}_{ij} ∈ {c}_{lq}}^{ } {v}_{ij}^{k} \times {a}_{ij}^{l} ; & ( 5 )\end{matrix}$$

where c_{lq} is cᵢⱼ's ascendant node on the lth level, 1≦l<i. For instance, as shown in FIG. 8, c₃₁'s ascendant node on the first level of the hierarchy is c₁₁, and its ascendant node on the second level is c₂₁. Thus, if I=2, c_{lq} refers to c₂₁ and (c₃₁, c₃₂)εc₂₁. Also, if l=1, c_{lq} denotes c₁₁, (c₃₁, c₃₂, . . . , c₃₅)εc₁₁.

Writing them in the matrix form, a denotes the column vector with all the authority scores, and h denotes the column vector with all the hub scores. For example, conditioned by the region of cluster c₁₁, a=(a₃₁¹, a₃₂¹, . . . , a₃₅¹), and h=(h₁₁¹, h₁₁², . . . , h₁₁⁵);

a=M·h; and (6)

h=M^{T}·a. (7)

If aₙ and hₙ are used to denote authority and hub scores at the nth iteration, the iterative processes for generating the final results are:

aₙ=M·M^{T}·aₙ₋₁; and (8)

hₙ=M^{T}·M·kₙ₋₁. (9)

Starting with a₀=h₀=(1, 1, . . . , 1), it is possible to calculate the authority and hub scores using the power iteration method.

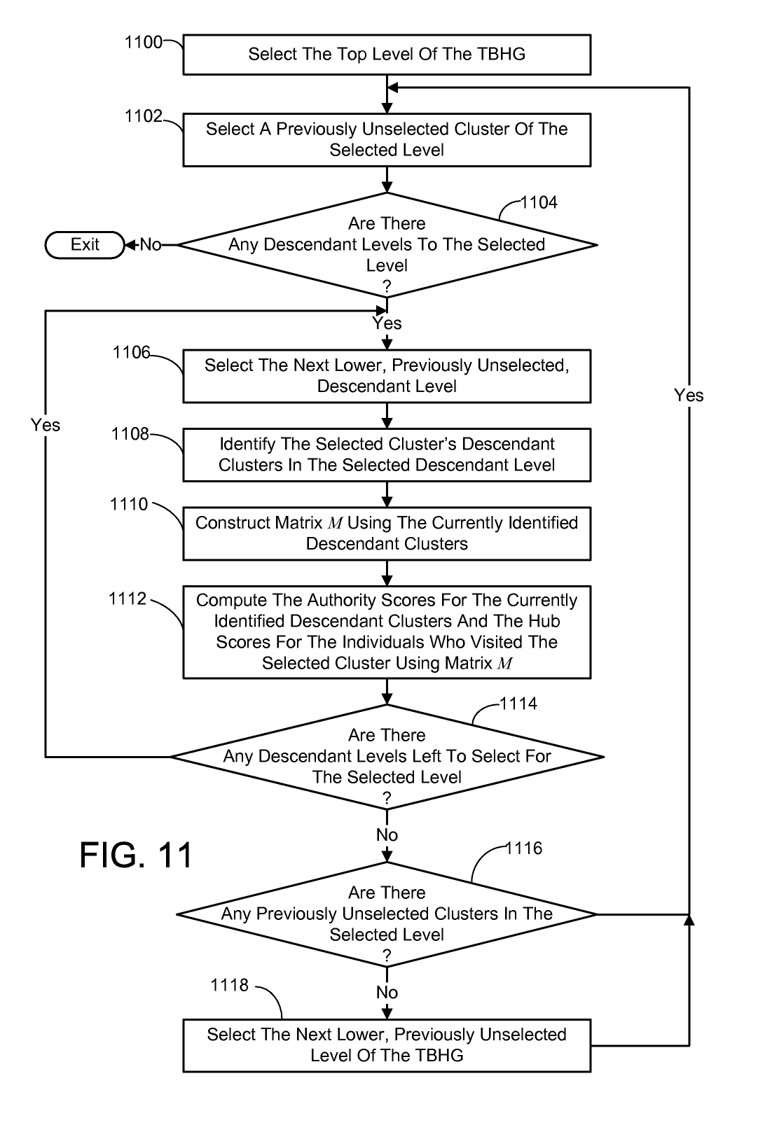

Given the foregoing, in one embodiment inferring each user's hub scores and the authority scores for each location is accomplished as follows. Referring to the flow diagram of FIG. 11, for each iteration, the process begins by selecting the top level of the TBHG (action 1100). A previously unselected cluster (location) of the selected level is then selected (action 1102). This is followed by determining if there are any descendant levels to the selected level (action 1104), as would be the case for all but the bottom level of the TBHG. If not, the iteration ends. However, if there are descendant levels, the next lower, previously unselected, descendant level is selected (action 1106). Next, the selected cluster's descendant clusters are identified in the selected descendant level (action 1108). The previously described matrix M is then constructed (action 1110), using the currently identified descendant clusters. It is noted that the list of individuals whose location data is being processed and the location visitation numbers (both of which are used to construct matrix M) are obtained from the previously described location histories (LocH). Matrix M is then used to compute the authority scores for the currently identified descendant clusters ({aₓⁱ}) and the hub scores (hᵢⱼ^{k}) for the individuals who visited the selected cluster (action 1112). These authority and hub scores are computed as described above. It is next determined if there are any descendant levels left to select for the selected level (action 1114). If so, actions 1106 through 1114 are repeated, until all the descendant levels have been considered. It is then determined if there are any remaining unselected clusters in the selected level (action 1116). If so, actions 1102 through 1116 are repeated. Once all the clusters in the selected level have been considered, the next lower, previously unselected level of the TBHG is selected (action 1118), and process actions 1102 through 1118 are repeated again.

By way of an example for identifying the selected cluster's descendant clusters in the foregoing process, assume the selected cluster is c₁₁. If the selected descendant level is the second level of the example TBHG, then {c₂₁, c₂₂} would be the descendant clusters. Similarly, if the selected descendant level is the third level of the example TBHG, then {c₃₁, c₃₂, . . . , c₃₅} would be the descendant clusters. Also note that {aₓⁱ} represents the collection of authority scores of the clusters contained in the selected descendant level that are associated with selected cluster.

### 1.2.3.5 Interesting Location Identification, Storing and Transfer

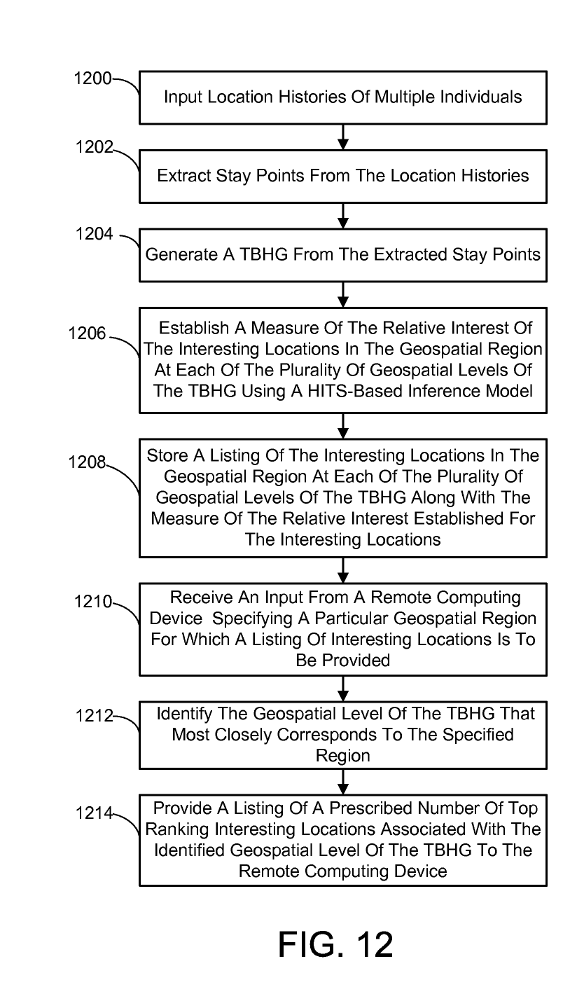

Referring to FIG. 12, an exemplary process is provided showing one way to implement the foregoing interesting location identification embodiments, including storing the results and transferring them to a remote computing device (such as a mobile telephone). The process begins by inputting location histories of multiple individuals (action 1200). These histories include a log of periodically captured geospatial locations which were visited by one or more of the individuals in the geospatial region over a period of time. Stay points are then extracted from the location histories (action 1202). As described previously, a stay point is a geospatial position in said region which is within a prescribed maximum distance of locations where an individual spent a period of time exceeding a prescribed minimum period. Next, a TBHG is generated from the extracted stay points (action 1204). This TBHG models the multiple individuals' stay points as interesting locations on each of a plurality of scaled geospatial levels. A hypertext induced topic search (HITS)-based inference model is then used to establish a measure of the relative interest of the interesting locations in the geospatial region at each of the plurality of geospatial levels of the TBHG based on the number of individuals visiting the location weighted in terms of the travel experience of the individuals visiting the location (action 1206). A listing of the interesting locations in the geospatial region at each of the plurality of geospatial levels of the TBHG is then stored along with the measure of the relative interest established for the interesting locations (action 1208). The storing of the interesting locations and their relative interest measures is particularly advantageous when these actions are carried out off-line and ahead of time. In embodiments (not shown) where the possible travel sequences between the interesting locations in the geospatial region at each of the plurality of geospatial levels of the TBHG are also identified as will be described in the next section, these can be stored as well, along with a measure of the relative popularity of the possible travel sequences based on the multiple individuals' transition probabilities between the interesting locations.

At any time after the interesting locations and their relative interest measures are stored, an input from a remote computing device can be received which specifies a particular geospatial region for which a listing of interesting locations is to be provided (action 1210). The geospatial level of the TBHG most closely corresponding with the specified region is then identified (action 1212), and a listing of a prescribed number of top ranking interesting locations associated with the identified geospatial level of the TBHG is provided to the remote computing device (action 1214). As indicated previously, the top ranking interesting locations are ranked in accordance with their measures of the relative interest. In the embodiments (not shown) where the possible travel sequences between the interesting locations in the geospatial region at each of the plurality of geospatial levels of the TBHG are also identified, a listing of a prescribed number of top ranking travel sequences between the top ranking interesting locations can also be provided to the remote computing device. The top ranking travel sequences are ranked in accordance with their measure of the relative popularity.

### 1.2.4 Common Travel Sequences

In one embodiment, the interesting location and experienced user data is mined to identify common travel sequences. These are travel sequences that users have taken in the past between locations in a given region. To rank the common travel sequences, a commonality score is calculated for possible location sequences within a given region by considering two factors—namely, the travel experiences of the users taking the sequence and the interesting locations contained in the sequence. Since multiple paths start from a location, the interest of the location is shared among all the paths to other locations. The interest of a location is allocated to different paths based on the transition probability of users' movements on these paths. The sequences are ranked based on their commonality scores, with relatively higher scores indicating a more popular travel sequence. In this way, the top m n-length sequences based on their commonality scores can be presented to a user inquiring as to interesting locations and common travel sequences in a specified region. As people would not travel to too many places in a journey, limiting the common travel sequences to no more than two or three locations is sufficient. However, longer journeys with more location could be designated if desired.

More particularly, commonality scores are calculated for each location sequence having a prescribed number of locations within a given geospatial as an integration of the following three parameters. First, the sum of hub scores of the users who have taken the sequence. Second, the authority scores of the locations contained in the sequence. And third, a weighting factor assigned to each authority score based on the transition probability of people's movements. Equation (10) below provides one version of how these parameters can be integrated to produce a commonality score:

$$\begin{matrix}{S}_{AC} = {\sum }_{{u}_{k} ∈ {U}_{AC}}^{ } ( {a}_{A} \cdot {Out}_{AC} + {a}_{C} \cdot {In}_{AC} + {h}^{k} ) \\ = \vert {U}_{AC} \vert \cdot ( {a}_{A} \cdot {Out}_{AC} + {a}_{C} \cdot {In}_{AC} ) + {\sum }_{{u}_{k} ∈ {U}_{AC}}^{ } {h}^{k}\end{matrix} \qquad ( 10 )$$

where S_{AC} is the commonality score for a path sequence from location A to location C, a_{A} is the authority score of location A, Out_{Ac} is a weighting factor representing the probability of a user moving out from location A to location C via the path sequence being evaluated, a_{C} is the authority score of location C, In_{AC} is a weighting factor representing the probability of a user moving in to location A from location C via the path sequence being evaluated, U_{AC} is the group of users who have taken the path sequence being evaluated, |U_{AC}| is the number of users who have take the path sequence, and h^{k} is the hub score of a user who has taken the path sequence being evaluated.

An example of the foregoing will now be described in the context of calculating a commonality score for a two location-length sequence from location A to location C (A→C). Referring to FIG. 13, consider an exemplary graph from a level of a TBHG constructed in the manner described previously. Here, the graph nodes 1300, 1302, 1304, 1306, 1308 (A, B, C, D and E respectively) represent locations, and the arrows 1310 between the nodes are graph edges representing user's transition sequences among the locations. The number 1312 shown on each edge represents the number of times users have taken the path between the two connected locations. Using Eq. (10), there are seven (5+2) links that point out to other nodes from node A, and five out of seven of these links are direct to node C. So, in this example Out_{Ac}= 5/7, i.e., only five sevenths of location A's authority (a_{A}) is assigned to sequence A→C, and the rest of a_{A} is assigned to A→B. Similarly, in this example, In_{Ac}=⅝ and |U_{AC}=5. Thus, the commonality score (S_{AC}) for sequence A→C is:

$$5 \times ( {a}_{A} \times \frac{5}{7} + {a}_{C} \times \frac{5}{8} ) + {\sum }_{{u}_{k} ∈ {U}_{AC}}^{ } {h}^{k} .$$

It is further noted that the commonality scores for sequences are additive. For example, if the commonality score for the two location-length sequence from location C to location D (C→D) were calculated using the example of FIG. 13, the result could be added to the commonality score of the A→C sequence to produce a commonality score for the three location-length sequence A→C→D. Thus:

S_{ACD}=S_{AC}+S_{CD}.

Using this additive paradigm, it is possible to calculate the commonality score of any n-length sequences. In view of this, it is possible to pre-calculate off-line all or many of the two location-length sequences for each geospatial region. These can then be combined to produce commonality scores for longer sequences as desired. For example, in one implementation the person inquiring about interesting locations and travel sequences in a region could also specify the desired length of the travel sequences.

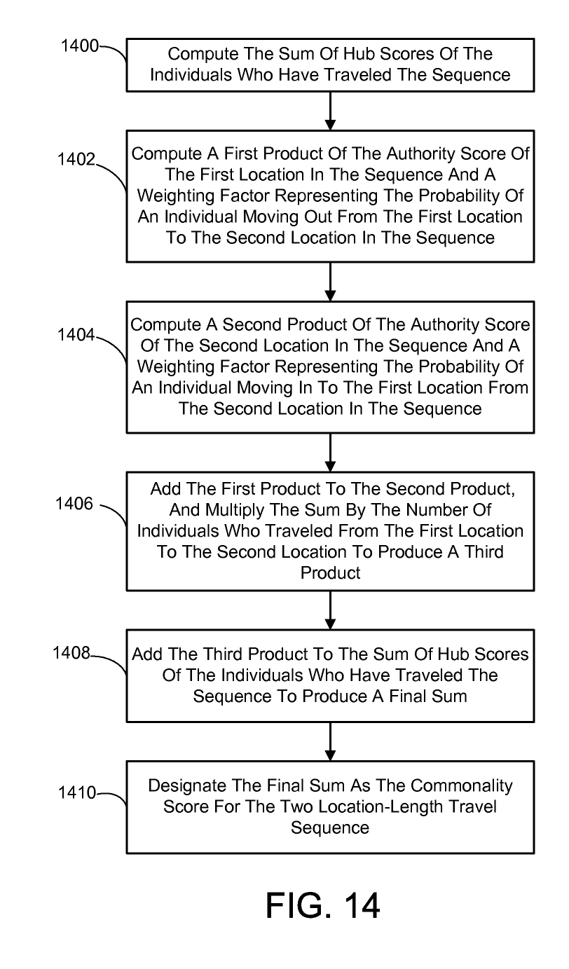

In view of the foregoing, computing a commonality score for a two location-length travel sequence can be accomplished in one implementation as shown in FIG. 14. First, the sum of hub scores of the individuals who have traveled the sequence is computed (action 1400). Next, a first product of the authority score of the first location in the sequence and a weighting factor representing the probability of an individual moving out from the first location to the second location in the sequence is computed (action 1402). Likewise, a second product is computed, this time of the authority score of the second location in the sequence and a weighting factor representing the probability of an individual moving in to the first location from the second location in the sequence (action 1404). The first product is added to the second product, and then the sum is multiplied by the number of individuals who traveled from the first location to the second location to produce a third product (action 1406). The third product is then added to the sum of hub scores of the individuals who have traveled the sequence to produce a final sum (action 1408). This final sum is designated as the commonality score for the two location-length travel sequence (action 1410).

### 2.0 THE COMPUTING ENVIRONMENT

A brief, general description of a suitable computing environment in which portions of the interesting location identification embodiments described herein may be implemented will now be described. The embodiments are operational with numerous general purpose or special purpose computing system environments or configurations. Examples of well known computing systems, environments, and/or configurations that may be suitable include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 15 illustrates an example of a suitable computing system environment. The computing system environment is only one example of a suitable computing environment and is not intended to suggest any limitation as to the scope of use or functionality of interesting location identification embodiments described herein. Neither should the computing environment be interpreted as having any dependency or requirement relating to any one or combination of components illustrated in the exemplary operating environment. With reference to FIG. 15, an exemplary system for implementing the embodiments described herein includes a computing device, such as computing device 10. In its most basic configuration, computing device 10 typically includes at least one processing unit 12 and memory 14. Depending on the exact configuration and type of computing device, memory 14 may be volatile (such as RAM), non-volatile (such as ROM, flash memory, etc.) or some combination of the two. This most basic configuration is illustrated in FIG. 15 by dashed line 16. Additionally, device 10 may also have additional features/functionality. For example, device 10 may also include additional storage (removable and/or non-removable) including, but not limited to, magnetic or optical disks or tape. Such additional storage is illustrated in FIG. 15 by removable storage 18 and non-removable storage 20. Computer storage media includes volatile and nonvolatile, removable and non-removable media implemented in any method or technology for storage of information such as computer readable instructions, data structures, program modules or other data. Memory 14, removable storage 18 and non-removable storage 20 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 10. Any such computer storage media may be part of device 10.

Device 10 may also contain communications connection(s) 22 that allow the device to communicate with other devices. Device 10 may also have input device(s) 24 such as keyboard, mouse, pen, voice input device, touch input device, camera, etc. Output device(s) 26 such as a display, speakers, printer, etc. may also be included. All these devices are well know in the art and need not be discussed at length here.

The interesting location identification embodiments described herein may be further described in the general context of computer-executable instructions, such as program modules, being executed by a computing device. Generally, program modules include routines, programs, objects, components, data structures, etc. that perform particular tasks or implement particular abstract data types. The embodiments described herein may also be practiced in distributed computing environments where tasks are performed by remote processing devices that are linked through a communications network. In a distributed computing environment, program modules may be located in both local and remote computer storage media including memory storage devices.

### 3.0 OTHER EMBODIMENTS

It is noted that any or all of the aforementioned embodiments throughout the description may be used in any combination desired to form additional hybrid embodiments. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Wherefore, what is claimed is:

1. A computer-implemented process for identifying interesting locations in a geospatial region, comprising:
using a computer to perform the following process actions,
modeling location histories of multiple individuals who traveled through the region, and
identifying interesting locations in the region based on a number of individuals visiting a location in the region weighted in terms of the travel experience of the individuals visiting the location.

2. The process of claim 1, wherein the process action of modeling the location histories of multiple individuals who traveled through the region, comprises the actions of:
inputting location histories of said multiple individuals, wherein the location history for an individual comprises a log of the geospatial locations of the individual captured periodically over a period of time;
identifying stay points from the location histories, wherein a stay point is a geospatial location in said region which is within a prescribed maximum distance of locations where an individual spent a period of time exceeding a prescribed minimum period; and
generating a tree-based hierarchical graph (TBHG) from the identified stay points, wherein the TBHG models the multiple individuals' stay points as interesting locations on each of a plurality of scaled geospatial levels.

3. The process of claim 2, wherein the process action of inputting location histories comprises an action of inputting a global positioning system (GPS) data logs each comprising a collection of GPS points representing the geospatial locations of an individual captured periodically over a period of time, wherein each GPS point comprises a latitude, a longitude and a timestamp.

4. The process of claim 3, wherein the process action of identifying stay points, comprises the actions of:
parsing the GPS logs for each individual into GPS trajectories, wherein each GPS trajectory comprises a series of trajectory segments formed by splitting a curve connecting sequential GPS points based on their timestamps wherein each segment corresponds to a part of the curve having a time interval between beginning and ending GPS trajectory points that exceeds a prescribed time period;
for each individual, identifying each group of GPS trajectory points wherein the distance between the points is less than or equal to a prescribed distance threshold and the time interval between the points equals or exceeds a prescribed time period; and
for each identified group of GPS trajectory points,
computing the average latitude and average longitude of the group,
establishing an arrival time for the group which corresponds to the timestamp of the earliest GPS trajectory point in the group,
establishing a leaving time for the group which corresponds to the timestamp of the latest GPS trajectory point in the group, and
establishing a stay point for the group comprising the average latitude, average longitude, arrival time and leaving time of the group.

5. The process of claim 2, wherein the process action of generating the TBHG, comprises the actions of:
clustering the identified stay points into a hierarchically multi-level tree; and
constructing a graph on each level, said graph comprising directed edges each of which connects a pair of stay point clusters each of which has one of two consecutive stay points associated with an individual.

6. The process of claim 5, wherein the process action of clustering the identified stay points, comprises an action of using a density-based clustering technique to cluster the identified stay points.

7. The process of claim 5, wherein the process action of clustering the identified stay points, comprises the actions of:
performing an initial clustering the identified stay points;
filtering the initial stay point clusters to eliminate stay points from consideration that likely correspond to an individual's home or workplace;
re-clustering the remaining identified stay points into a hierarchically multi-level tree

8. The process of claim 7, wherein the process action of filtering the initial stay point clusters, comprises the actions of:
for each individual and each cluster, determining a number of stay points associated with the that individual which are part of the cluster;
ascertaining if the number of stay points associated with the same individual in the same cluster exceeds a prescribed maximum number; and
whenever it is ascertained the number of stay points associated with the same individual in the same cluster exceeds the prescribed maximum number, eliminating those stay points from a cluster.

9. The process of claim 2, wherein the process action of identifying interesting locations in the region, comprises an action of employing a hypertext induced topic search (HITS)-based inference model to establish a relative interest of a visited location in the geospatial region of interest.

10. The process of claim 9, wherein the process action of employing a HITS-based inference model to establish the relative interest of a visited location in the geospatial region of interest, comprises an action of establishing a measure of the relative interest of the identified interesting locations at each of the plurality of geospatial levels of the TBHG, wherein said relative interest measure comprises a collection of authority scores generated based on an authority score of each geospatial region corresponding to the interesting location in ascendant levels of the TBHG, which are in turn based on hub scores associated with geospatial regions corresponding to the interesting locations in ascendant levels of the TBHG and which represent the degree of travel experience of an individual.

11. The process of claim 10, further comprising a process action of identifying users among the multiple individuals who traveled through the region that have a relatively higher degree of travel experience in the region than others of the individuals.

12. The process of claim 11, further comprising a process action of identifying commonly used travel sequences between the identified interesting locations in the geospatial region based on said multiple individuals' transition probabilities between locations.

13. The process of claim 12, wherein the process action of identifying commonly used travel sequences, comprises the process actions of:
computing a commonality score for possible location travel sequences, wherein the commonality score is based on the sum of hub scores of the individuals who have traveled the sequence and the authority scores associated with the locations contained in the sequence weighted by the transition probability of the individuals' movements; and
ranking the location travel sequences based on their commonality scores, with relatively higher scores indicating a more popular travel sequence.

14. The process of claim 13, wherein the process action of computing a commonality score for possible location travel sequences, comprises the actions of:
computing a commonality score for possible two location-length travel sequences in the geospatial region of interest; and
whenever a commonality score is generated for a travel sequence longer than two locations, computing the commonality score of the longer sequence by adding the commonality scores of the two location-length travel sequences making up the longer sequence.

15. The process of claim 14, wherein computing a commonality score for a two location-length travel sequence, comprises the actions of:
computing the sum of hub scores of the individuals who have traveled the sequence;
computing a first product of the authority score of the first location in the sequence and a weighting factor representing the probability of an individual moving out from the first location to the second location in the sequence;
computing a second product of the authority score of the second location in the sequence and a weighting factor representing the probability of an individual moving in to the first location from the second location in the sequence;
adding the first product to the second product and multiplying the resulting sum by the number of individuals who traveled from the first location to the second location to produce a third product;
adding the third product to the sum of hub scores of the individuals who have traveled the sequence to produce a final sum; and
designating the final sum to be the commonality score for the two location-length travel sequence.

16. A system for providing a listing of interesting locations in a geospatial region, comprising:
a general purpose computing device comprising a storage memory; and
a computer program comprising program modules executable by the computing device, wherein the computing device is directed by the program modules of the computer program to,
input location histories of multiple individuals comprising a log of periodically captured geospatial locations which were visited by one or more of the individuals in the geospatial region over a period of time,
extract stay points from the location histories, wherein a stay point is a geospatial position in said region which is within a prescribed maximum distance of locations where an individual spent a period of time exceeding a prescribed minimum period,
generate a tree-based hierarchical graph (TBHG) from the extracted stay points, wherein the TBHG models the multiple individuals' stay points as interesting locations on each of a plurality of scaled geospatial levels,
employ a hypertext induced topic search (HITS)-based inference model to establish a measure of the relative interest of the interesting locations in the geospatial region at each of the plurality of geospatial levels of the TBHG based on the number of individuals visiting the location weighted in terms of the travel experience of the individuals visiting the location, and
store a listing of the interesting locations in the geospatial region at each of the plurality of geospatial levels of the TBHG along with the measure of the relative interest established for the interesting locations.

17. The system of claim 16, further comprising program modules for:
receiving an input from a remote computing device having a display which specifies a particular geospatial region for which a listing of interesting locations is to be provided;
identifying the geospatial level of the TBHG most closely corresponding with the specified region, and
providing a listing of a prescribed number of top ranking interesting locations associated with the identified geospatial level of the TBHG to the remote computing device, wherein the top ranking interesting locations are ranked in accordance with their measure of the relative interest.

18. The system of claim 17, wherein:
the program module for receiving the input from the remote computing device specifying the particular geospatial region, comprises a sub-module for receiving the input in a form of data representing a map of the specified region, wherein a user of the remote device viewed and selected a map of a region of interest on the display of the remote computing device and transferred data representing a map to said general purpose computing device; and
the program module for providing the listing of the prescribed number of top ranking interesting locations, comprises a sub-module for providing the listing of top ranking interesting locations in a form of data representing a map which is displayable on the display of the remote computing device, and which when displayed highlights the location of each of the top ranking interesting locations at an appropriate place on the map.

19. The system of claim 17, further comprising program modules for:
identifying possible travel sequences between the interesting locations in the geospatial region at each of the plurality of geospatial levels of the TBHG;
computing a measure of the relative popularity of the possible travel sequences based on said multiple individuals' transition probabilities between the interesting locations;
storing the identified possible travel sequences along with the measure of their relative popularity computed for each of the sequences; and
whenever the listing of the prescribed number of top ranking interesting locations associated with the identified geospatial level of the TBHG is provided to the remote computing device, additionally providing a listing of a prescribed number of top ranking travel sequences between the top ranking interesting locations to the remote computing device, wherein said top ranking travel sequences are ranked in accordance with the measure of their relative popularity.

20. A computer-readable storage medium having computer-executable instructions stored thereon for identifying interesting locations and experienced travelers in a geospatial region, said computer-executable instructions comprising:
inputting location histories of multiple individuals comprising a log of periodically captured geospatial locations which were visited by one or more of the individuals in the geospatial region over a period of time;
extracting stay points from the location histories, wherein a stay point is a geospatial location in said region which is within a prescribed maximum distance of locations where an individual spent a period of time exceeding a prescribed minimum period;
generating a tree-based hierarchical graph (TBHG) from the identified stay points, wherein the TBHG models the multiple individuals' stay points as interesting locations on each of a plurality of scaled geospatial levels; and
employing a hypertext induced topic search (HITS)-based inference model to establish a measure of the relative interest of the interesting locations and a measure of the travel experience of each of the multiple individuals, in the geospatial region at each of the plurality of geospatial levels of the TBHG.
